(19) United States
(12) Patent Application Publication
(10) Pub. No.: US 2025/0335993 A1
(43) Pub. Date: Oct. 30, 2025

(54) INFORMATION PROCESSING DEVICE AND PROGRAM

(71) Applicant: READY-MIXED & RETURNED CONCRETE SOLUTION ASSOCIATION, Tokyo (JP)

(72) Inventors: Takafumi NOGUCHI, Tokyo (JP); Shigeatsu FUJII, Tokyo (JP)

(73) Assignee: READY-MIXED & RETURNED CONCRETE SOLUTION ASSOCIATION, Tokyo (JP)

(21) Appl. No.: 19/106,805

(22) PCT Filed: Sep. 1, 2023
(86) PCT No.: PCT/JP2023/032067

§ 371 Date: Feb. 26, 2025

(30) Foreign Application Priority Data
Sep. 1, 2022 (JP) 2022-139585

(51) Int. Cl. G06Q 40/04

(52) U.S. Cl. CPC G06Q 40/049

(57) ABSTRACT

A server 1 comprises: an absorption amount calculation unit 31 which calculates an absorption amount of carbon dioxide of a cement product CP on the basis of an absorption capability required according to product information about the cement product; a use state management unit 33 which associates the calculated absorption amount with each cement product and manages the associated results; and an absorption amount correction unit 34 which frequently corrects the absorption amount on the basis of the use state or a use environment of the cement product, wherein the absorption amount of the carbon dioxide is managed by means of a database with increased reliability. In addition, the server 1 further comprises an authentication recording unit 36 which associates each cement product with a carbon credit issued on the basis of the calculated absorption amount and records the associated results, and the server manages the carbon credit and performs a safe trade.

### TECHNICAL FIELD

The present invention relates to an information processing apparatus and a program.

### BACKGROUND ART

Greenhouse gases, which are the primary cause of global warming, have significantly increased in emissions due to human economic activities and other factors. Consequently, it is reported that the global average temperature has risen by 0.85° C. between 1880 and 2012. If this situation remains unaddressed and global warming continues, it is projected that the average temperature could rise by as much as 4.8° C. by the end of the 21^{st} century.

Since the establishment of the Kyoto Protocol in 1997, the reduction of greenhouse gas emissions has been mandated. As part of corporate social responsibility (CSR) and creating shared value (CSV) by companies, organizations and the like, the transactions of carbon credits (carbon dioxide emission rights) has garnered attention. Carbon credits quantify (numerically express) the effects of reducing or absorbing carbon dioxide (CO₂), a type of greenhouse gas, through energy-saving activities, afforestation, and other measures, making them tradable.

Meanwhile, it is known that concrete can fix (absorb) carbon dioxide. Specifically, cement, which is one of the materials in concrete, reacts with water to generate cement hydrates such as calcium hydroxide (Ca(OH)₂). On the other hand, carbon dioxide that penetrates from the surface into the interior through the fine gaps (capillary pores) in the concrete reacts with these cement hydrates and becomes fixed as calcium carbonate (CaCO₃).

In order to reduce the carbon dioxide emission amount, various technologies have been proposed for measuring emissions and trading emission rights. For example, systems have been proposed that focus on the carbon dioxide absorption capacity inherent in concrete and assess the carbon dioxide absorption capacity of concrete components, structures, or waste materials, while utilizing carbon dioxide emission rights (e.g., Patent Document 1).

### CITATION LIST

### Patent Document

Patent Document 1: Japanese Unexamined Patent Application, Publication No. 2006-323593

### DISCLOSURE OF THE INVENTION

### Problems to be Solved by the Invention

However, in Patent Document 1, the carbon dioxide absorption capacity is calculated based on the material properties of concrete. Therefore, changes in carbon dioxide absorption capacity over time are unclear, which has hindered participation in transactions of carbon dioxide emission rights.

In view of these circumstances, an object of the present invention is to propose important technology that serves as a prerequisite for the appropriate issuance or transactions of carbon credits related to greenhouse gas-absorbing products.

### Means for Solving the Problems

One aspect of the present invention is an information processing apparatus, including:
an absorption amount acquisition unit configured to acquire an estimated value of a greenhouse gas absorption amount during a process until a greenhouse gas-absorbing product becomes unusable, based on a greenhouse gas absorption capacity determined in accordance with product information on the greenhouse gas-absorbing product;
a usage status management unit configured to manage the absorption amount acquired, in association with each greenhouse gas-absorbing product; and
an absorption amount correction unit configured to correct the absorption amount associated with each greenhouse gas-absorbing product as needed, based on progress information on a processing status, a usage status, or a usage environment of the greenhouse gas-absorbing product.

One aspect of the present invention is an information processing apparatus, including:
an absorption amount acquisition unit configured to acquire an estimated value of a greenhouse gas absorption amount during a process until a greenhouse gas-absorbing product becomes unusable, based on a greenhouse gas absorption capacity determined in accordance with product information on the greenhouse gas-absorbing product;
a usage status management unit configured to manage the greenhouse gas absorption amount acquired, in association with each greenhouse gas-absorbing product; and
a certification recording unit configured to record carbon credits issued for the greenhouse gas-absorbing product by matching and associating the carbon credits with the greenhouse gas-absorbing product.

The information processing apparatus may further include a history management unit configured to manage a correction history and a correction result corrected by the absorption amount correction unit, in association with each greenhouse gas-absorbing product.

The product information may include at least one of a type, amount, or composition of a raw material used in the greenhouse gas-absorbing product, breathability, moisture content, strength, or construction conditions of the greenhouse gas-absorbing product. The absorption amount acquisition unit may acquire an estimated value of an absorption amount, based on an absorption capacity determined in accordance with the product information.

The product information may include aging and service life of the greenhouse gas-absorbing product.

The information processing apparatus may further include a transaction price determination unit configured to determine a transaction price of carbon credits to be issued in future.

One aspect of the present invention is an information processing method, including:
an absorption amount acquiring step of acquiring an estimated value of a greenhouse gas absorption amount during a process until a greenhouse gas-absorbing product becomes unusable, based on a greenhouse gas absorption capacity determined in accordance with product information on the greenhouse gas-absorbing product;
a usage status managing step of managing the absorption amount acquired in association with each greenhouse gas-absorbing product; and
an absorption amount correcting step of correcting the absorption amount associated with each greenhouse gas-absorbing product as needed, based on progress information regarding a processing status, a usage status, or a usage environment of the greenhouse gas-absorbing product.

One aspect of the present invention is an information processing method, including:
an absorption amount acquiring step of acquiring an estimated value of a greenhouse gas absorption amount during a process until a greenhouse gas-absorbing product becomes unusable, based on a greenhouse gas absorption capacity determined in accordance with product information on the greenhouse gas-absorbing product;
a usage status managing step of managing the absorption amount acquired in association with each greenhouse gas-absorbing product; and
a certification recording step of recording carbon credits issued for the greenhouse gas-absorbing product by matching and associating the carbon credits with the greenhouse gas-absorbing product.

One aspect of the present invention is a computer program for causing a computer to execute:
an absorption amount acquiring step of acquiring an estimated value of a greenhouse gas absorption amount during a process until a greenhouse gas-absorbing product becomes unusable, based on a greenhouse gas absorption capacity determined in accordance with product information on the greenhouse gas-absorbing product;
a usage status managing step of managing the absorption amount acquired in association with each greenhouse gas-absorbing product; and
an absorption amount correcting step of correcting the absorption amount associated with each greenhouse gas-absorbing product as needed, based on progress information regarding a processing status, a usage status, or a usage environment of the greenhouse gas-absorbing product.

One aspect of the present invention is a computer program for causing a computer to execute:
an absorption amount acquiring step of acquiring an estimated value of a greenhouse gas absorption amount during a process until a greenhouse gas-absorbing product becomes unusable, based on a greenhouse gas absorption capacity determined in accordance with product information on the greenhouse gas-absorbing product;
a usage status managing step of managing the acquired greenhouse gas absorption amount in association with each greenhouse gas-absorbing product; and
a certification recording step of recording carbon credits issued for the greenhouse gas-absorbing product by matching and associating the carbon credits with the greenhouse gas-absorbing product.

### Effects of the Invention

The present invention can propose important technology that serves as a prerequisite for the appropriate issuance or transactions of carbon credits related to greenhouse gas-absorbing products.

### BRIEF DESCRIPTION OF THE DRAWINGS

FIG. 1 is a diagram illustrating an overview of the carbon dioxide absorption amount capacity tracing system;

FIG. 2 is a diagram illustrating the configuration of the carbon dioxide absorption amount capacity tracing system;

FIG. 3 is a hardware configuration diagram of the server;

FIG. 4 is a functional block diagram of the server;

FIG. 5 is a flowchart illustrating an example of carbon dioxide absorption amount trace processing;

FIG. 6 is a diagram illustrating an example of carbon dioxide absorption amount tracing;

FIG. 7 is a flowchart illustrating an example of carbon credit management processing;

FIG. 8 is a flowchart illustrating another example of carbon credit management processing;

FIG. 9 is a flowchart illustrating an example of transaction price determination processing for carbon credits;

FIG. 10 is a diagram illustrating an example of carbon credit transactions; and

FIG. 11 is a diagram illustrating an example of a call option in carbon credit transactions.

### PREFERRED MODE FOR CARRYING OUT THE INVENTION

### Overview

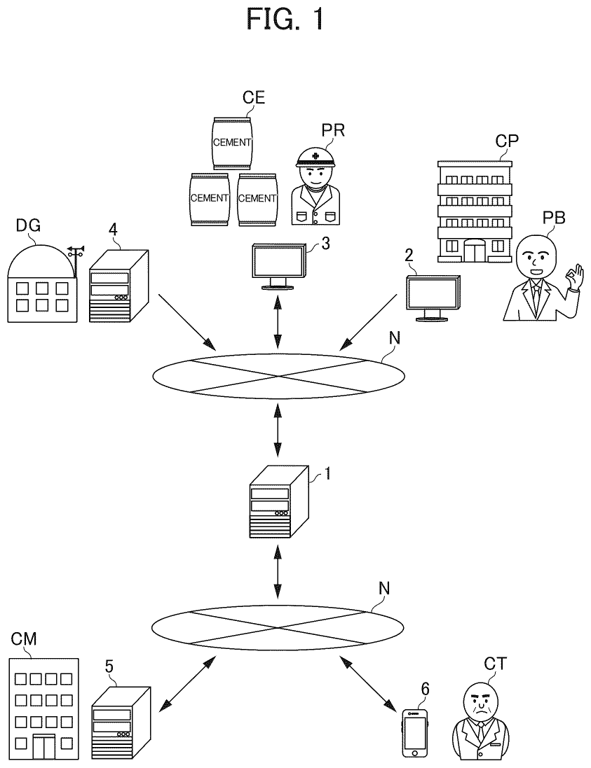

Hereinafter, the present embodiment will be described with reference to the drawings. FIG. 1 is a diagram illustrating an overview of the carbon dioxide absorption amount capacity tracing system according to the present embodiment. In the present embodiment, the server 1 calculates the carbon dioxide absorption amount (estimated value), which is an amount of carbon dioxide to be absorbed by a cement product CP in the future, based on the carbon dioxide absorption capacity of the cement product CP. The server 1 corrects the calculated carbon dioxide absorption amount (estimated value) as needed, based on various information. The server 1 also manages the history of the corrected carbon dioxide absorption amounts. As a result, reliability can be enhanced for carbon credit traders. In addition to cement products, products capable of absorbing and fixing greenhouse gases are collectively referred to as “greenhouse gas-absorbing products” hereinafter. Examples include biomass-derived biofuels, among others.

The present embodiment also describes the examples of the server 1 performing transactions for selling and purchasing carbon credits (carbon credits scheduled to be issued in the future), which correspond to the carbon dioxide absorption amount, with traders CT. The server 1 manages carbon credits issued by a carbon credit certification organization, based on the absorption amount calculated for the cement product CP. In other words, the traders CT can trade carbon credits through the server 1. In the present embodiment, the server 1 functions as a carbon dioxide absorption amount tracing device, and as a carbon credit management device, but may function as either one independently. The carbon credits are not limited to carbon dioxide but may cover all types of greenhouse gases.

As illustrated in FIG. 1, the server 1 acquires various types of information, such as:
Product information of the cement product CP from the cement product business operator PB;
Progress information regarding the usage status of the cement product CP from the cement product business operator PB;
Progress information regarding the processing status or usage environment of the cement product CP from the information gathering company DG;
Manufacturing plan information of the cement product CP from the cement product business operator PB; and
Sales information of the cement CE from the cement producer PR.

The cement product CP refers to either the cement CE itself as a raw material, or concrete products made using the cement CE as a raw material. Concrete products include precast products manufactured in factories, structures (constructions) constructed by casting concrete on-site, recycled waste materials (waste cement materials), cement paste made by kneading cement CE with water, and cement mortar made by mixing cement paste with sand. Examples of concrete products include large structures such as apartments, buildings, dams, ports, and bridges; elevated road pillars; curbstones; coastal protection blocks; sleepers; beams; utility poles; fences, and the like. Additionally, concrete products may also include buildings (bulk products) within a specific area, such as groups of buildings in Chiyoda Ward. Soil contains many microorganisms such as bacteria and fungi, which decompose organic matter in the soil and release carbon dioxide. Therefore, cement products CP may include spiles (piles) embedded in building foundations, hume concrete pipes, maintenance holes, and gutters buried underground. In the present embodiment, the server 1 estimates the capacity to absorb carbon dioxide during a period until the cement product becomes unusable, such as a period from the time of producing the cement product CP (e.g., construction) to the time of disposal (e.g., demolition), or from the generation to disposal of reusable waste concrete materials. The greenhouse gas-absorbing products in the present embodiment include recently developed “Calcium Carbonate Concrete (CCC)”. “CCC” is a concrete product obtained by chemically processing crushed used concrete to enhance the capacity to absorb and fix carbon dioxide. The chemical treatment (manufacturing method) for this product is described in detail below:
First, used concrete is crushed and placed in a water tank in a state where calcium (Ca) can be easily extracted, while simultaneously absorbing CO₂ from the air. Next, by utilizing the reaction of calcium (Ca) and CO₂ in the water tank to revert to limestone, calcium carbonate is generated as a binder. Finally, the calcium carbonate generated between the crushed particles of used concrete precipitates and hardens to form a concrete product. In addition to the aforementioned biofuels, greenhouse gas-absorbing products also include various concrete products obtained through different processing methods that enhance the capacity to absorb and fix greenhouse gases. In this specification, the term “processing status” refers to the condition where the greenhouse gas absorption capacity (absorption limit) has been enhanced by crushing the recovered cement product and conducting the above-described chemical treatment.

The cement product business operator PB is a business operator that manufactures cement products CP. Examples of the cement product business operator PB include construction companies, building owners, cement product manufacturers, demolition contractors, and secondary users of waste cement materials. The information gathering company DG is a business operator that collects progress information on usage environments. The cement producer PR is a business operator that produces and sells cement CE, which serves as a raw material for cement products CP. The carbon credit certification organization CM is an organization that conducts carbon offset certification or carbon-neutral certification, based on a prescribed carbon offset certification system. The trader CT is a person (user) who engages in transactions such as the sale and purchase of carbon credits.

Product information is a parameter used to determine the absorption capacity of cement products CP. Examples of product information include the name and product number of the cement product CP, the type of cement CE, the amount and composition of cement CE, cement content, breathability, moisture content, strength, surface area (particularly the area of the surface exposed to air), physical structure, such as the size or volume (%) of voids in the surface layer of the cement product CP, as well as the type (name), size (quantity), weight, service life, aging, and construction conditions of the cement product CP. The estimated service life for commercial properties with is approximately 47 years from the previous construction of reinforced concrete. The estimated service life for non-commercial properties is similarly 70 years.

Progress information refers to the state of the cement product CP over time. Examples of progress information include the production (construction) date of the cement product CP, installation (construction) location (address), installation method, surrounding environment (geographical conditions) of the cement product CP, as well as factors such as breathability, moisture content, strength, composition, and construction conditions of the cement product CP.

Manufacturing plan information refers to the product information of the cement products CP scheduled to be produced.

Sales information refers to information on the cement CE, such as the date and time of sales or sales destination of the cement product CE, and type and quantity of the cement CE.

### System Configuration

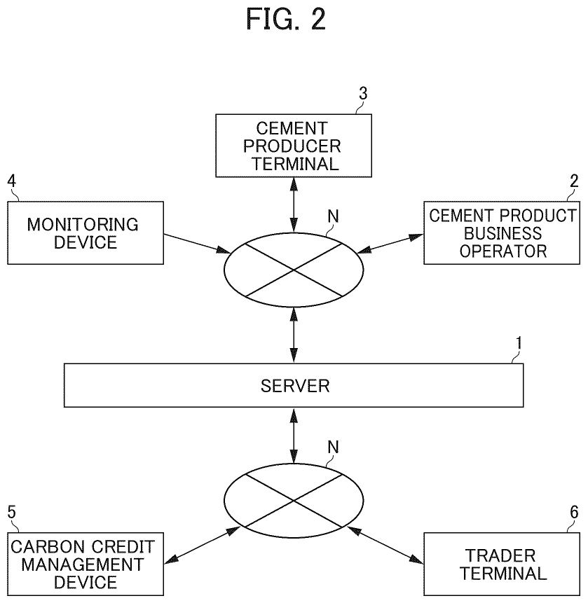

FIG. 2 is a diagram illustrating the configuration of the carbon dioxide absorption amount capacity tracing system. In the carbon dioxide absorption amount capacity tracing system according to the present embodiment, the server 1, a cement product business operator terminal 2, a cement producer terminal 3, a monitoring device 4, a carbon credit management device 5, and a trader terminal 6 are interconnected via a predetermined network N such as the Internet.

The server 1 serves both as a device that traces the carbon dioxide absorption amount for the cement products CP, and as a device that manages carbon credits issued based on the traced carbon dioxide absorption amount as well as carbon credits scheduled to be issued in the future, and is equipped with the arithmetic processing function and the communication function. The server 1 is implemented by, for example, using electronic devices such as a server device or a personal computer.

The cement product business operator terminal 2 is a computer operated by the cement product business operator PB, and is equipped with the arithmetic processing function and the communication function. The cement product business operator terminal 2 is implemented using a desktop or laptop computer, tablet computer, smartphone, or similar devices.

The cement producer terminal 3 is a computer operated by the cement producer PR, and is equipped with the arithmetic processing function and the communication function. The cement producer terminal 3 is also implemented using a desktop or laptop computer, tablet computer, smartphone, or similar devices.

The monitoring device 4 is installed at the information gathering company DG, and is equipped with the arithmetic processing function and the communication function. The monitoring device 4 is implemented using a server device, a personal computer, or other electronic devices. Examples of the monitoring device 4 include weather observation devices that collect and measure weather information that shows the usage environment of the cement product CP. Examples of progress information regarding the usage environment acquired by the monitoring device 4 include weather information such as temperature (ambient temperature), humidity, atmospheric CO₂ concentration, sunlight duration, heavy rain, heavy snow, strong winds, blizzards, high waves, lightning, hail, and tidal levels. Accordingly, the monitoring device 4 periodically acquires progress information regarding the usage environment.

The carbon credit management device 5 is a device that issues carbon credits, based on the carbon dioxide absorption amount, and is equipped with the arithmetic processing function and the communication function. A carbon credit is issued by measuring the emission reduction amount or absorption amount for carbon dioxide, and certifying the emission reduction amount or the absorption amount as a credit, which becomes a tradable asset. Since carbon credits are intangible assets, improper management may lead to issues such as duplicate transactions or a lack of substantiation for actual carbon dioxide reduction. Therefore, appropriate certification systems to guarantee that actual carbon dioxide reduction or absorption supports the carbon credit and an appropriate management to prevent duplicate transactions of the same carbon credit are required. In order to validate carbon credits, an independent third-party auditing organization, such as a carbon credit certification organization, is required to comprehensively evaluate, judge and review a series of processes and evidence. The carbon credit management device 5 is installed in an institution different from the aforementioned carbon credit certification organization. The carbon credit management device 5 calculates a forecast value of future carbon credits to be issued, based on the future absorption amount, taking into account the environment surrounding the cement product CP. The carbon credit management device 5 is implemented using electronic devices such as a server device or a personal computer.

The trader terminal 6 is a computer operated by the trader CT, and is equipped with the arithmetic processing function and the communication function. The trader terminal 6 is also implemented using a desktop or laptop computer, tablet computer, smartphone, or similar devices.

### Hardware Configuration

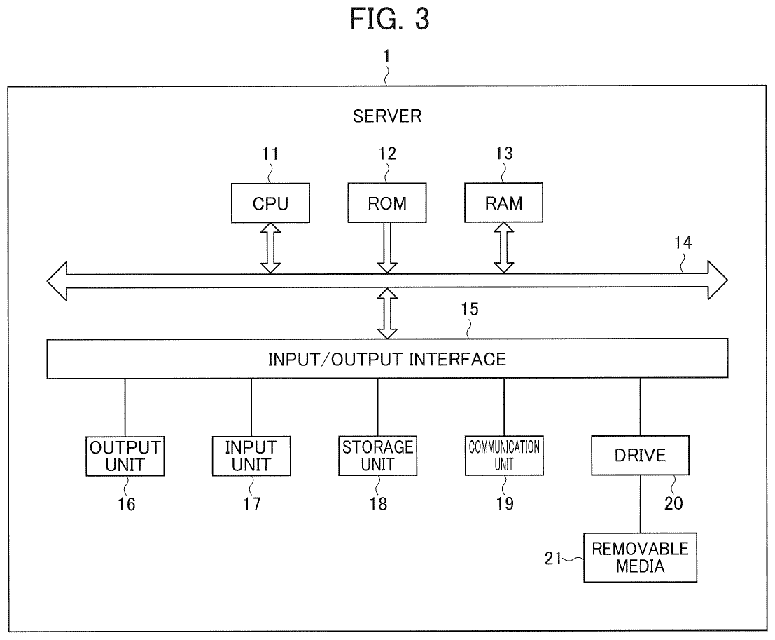

FIG. 3 is a block diagram illustrating the hardware configuration of the server 1 according to the present embodiment. The server 1 includes a central processing unit (CPU) 11, a read-only memory (ROM) 12, a random access memory (RAM) 13, a bus 14, an input/output interface 15, an output unit 16, an input unit 17, a storage unit 18, a communication unit 19, and a drive 20.

The CPU 11 executes various processing in accordance with programs stored in the ROM 12 or programs loaded from the storage unit 18 into the RAM 13. Specifically, the CPU 11 is a processor that controls the overall operation of the server 1 by executing various processing in accordance with programs. The programs include, for example, operating systems and firmware for operating the server 1 and application software for implementing the functional blocks described later.

The RAM 13 also appropriately stores data necessary for the CPU 11 to execute various processing. The CPU 11, the ROM 12, and the RAM 13 are interconnected via the bus 14. The input/output interface 15 is also connected to the bus 14. The output unit 16, the input unit 17, the storage unit 18, the communication unit 19, and the drive 20 are connected to the input/output interface 15.

The output unit 16 is configured by devices such as a display and speaker, outputting various types of information as images or audio. The input unit 17 is configured by devices such as a keyboard, mouse, and microphone, receiving instructions from the user U. The input unit 17 inputs various information in accordance with the received instructions. For example, a touch panel may be used to integrate the output unit 16 and the input unit 17.

The storage unit 18 stores various types of data necessary for the server 1 to execute information processing, and is configured by a hard disk or dynamic random access memory (DRAM). The communication unit 19 executes communication with other devices via a network N that includes the Internet.

The drive 20 is configured to appropriately mount removable media 21, such as magnetic disks, optical disks, magneto-optical disks, or semiconductor memory. Programs read from the removable media 21 by the drive 20 are installed in the storage unit 18 as needed. The removable media 21 can store various types of data stored in the storage unit 18, like the storage unit 18 does.

The server 1 is not limited to a standalone device and may include a distributed server system that operates cooperatively by communicating over the network N, or one or more servers connected to the network N, such as the Internet, generally referred to as cloud servers or cloud storage. The hardware configurations of the cement product business operator terminal 2, the cement producer terminal 3, the monitoring device 4, the carbon credit management device 5, and the trader terminal 6 are the same as the hardware configuration of the server 1 described above, and thus, detailed descriptions are omitted.

### Functional Configuration

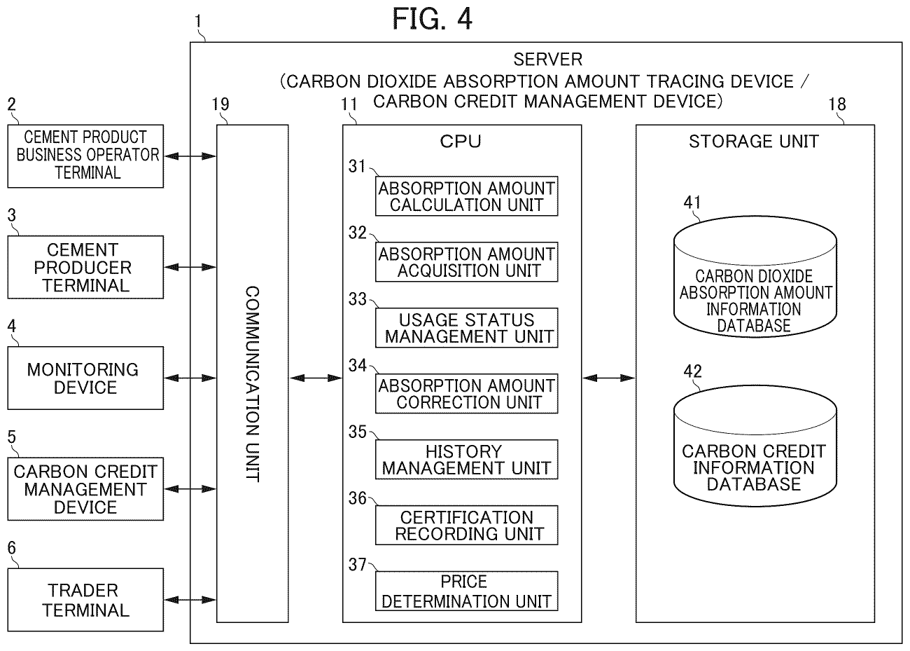

FIG. 4 is a functional block diagram illustrating an example of the functional configuration of the server 1 according to the present embodiment. In the CPU 11 of the server 1, the following components function during operation: an absorption amount calculation unit 31, an absorption amount acquisition unit 32, a usage status management unit 33, an absorption amount correction unit 34, a history management unit 35, a certification recording unit 36, and a price determination unit 37.

The absorption amount calculation unit 31 calculates an amount (estimated value) of carbon dioxide absorption during the process until the cement product CP becomes unusable, based on the absorption capacity determined in accordance with product information on the cement product CP. The absorption amount correction unit 34 manages the corrected absorption amount in association with each product. The calculation of the amount (estimated value) of carbon dioxide absorption in the cement product CP can be executed using known methods. For example, the calculation can be made based on the amount of cement hydrates, specifically calcium hydroxide and calcium silicate hydrates, which react with carbon dioxide and become fixed as calcium carbonate through carbonation reactions. The product information may include one or more factors such as the type of cement CE used in the cement product CP, the amount and composition of the cement CE, breathability, moisture content, strength, and construction conditions of the cement product CP. The product information preferably includes the aging and service life of the cement product CP. In this case, the carbon dioxide absorption amount can be determined by dividing the usage conditions of the cement product CP into a plurality of levels (e.g., Level A to Level C) for each of the above-mentioned factors and multiplying by a predetermined coefficient for each level.

The absorption amount calculation unit 31 may predict and calculate the absorption amount, based on the absorption capacity determined in accordance with product information such as the manufacturing plan information of the cement product CP and the sales information of the cement CE that serves as the raw material for the cement product CP. In other words, the predicted value (estimated value) is calculated for the absorption amount during the period until the cement product CP becomes unusable, which was manufactured based on the production plan or manufactured using the sold cement CE.

The absorption amount calculation unit 31 may acquire the product information on the cement product CP, the manufacturing plan information of the cement product CP, and the sales information of the cement CE, from other devices or from various databases pre-stored in the storage unit 18.

The absorption amount acquisition unit 32 acquires the absorption amount during the process until the cement product becomes unusable, based on the absorption capacity determined in accordance with product information on the cement product. In the present embodiment, the absorption amount acquisition unit 32 acquires the absorption amount calculated by the absorption amount calculation unit 31 described above; however, the present embodiment is not limited to this configuration and may acquire the absorption amount calculated by an external device. Therefore, the configuration of the absorption amount calculation unit 31 is not essential.

The usage status management unit 33 manages the absorption amount calculated by the absorption amount calculation unit 31 in association with each cement product CP. Specifically, the usage status management unit 33 manages the absorption amount calculated by the absorption amount calculation unit 31 in accordance with the above-mentioned factors, or the absorption amount calculated by the absorption amount calculation unit 31 in accordance with the aging and service life of the cement product CP, in association with each cement product CP. In other words, the usage status management unit 33 manages the absorption amount calculated in accordance with factors such as breathability, moisture content, strength, type of cement CE, composition, and construction conditions of the cement product CP, as well as weather information including temperature (ambient temperature), humidity, and atmospheric CO2 concentration, and the absorption capacity determined in accordance with the service life, in association with each cement product CP. The usage status management unit 33 may also manage the absorption amount corrected based on the progress information by the absorption amount correction unit 34, the absorption amount calculated based on the manufacturing plan information by the absorption amount calculation unit 31, or the absorption amount (predicted value) calculated based on the sales information of cement CE by the absorption amount calculation unit 31, in association with each sales information of cement CE.

The usage status management unit 33 may manage the absorption amount using the distributed ledger technology (blockchain). The distributed ledger technology is a technology that records or stores who wrote what information in the ledger when, in a manner that makes falsification or tampering extremely difficult, in which a plurality of parties (companies) share a single ledger. For example, the distributed ledger technology may be implemented as a consortium-type blockchain technology for sharing information among organizations (corporate consortia) composed of a plurality of parties. Compared to conventional information system technology, the distributed ledger technology improves ledger reliability and enables equal information sharing.

The absorption amount correction unit 34 corrects the absorption amount associated with each cement product CP as needed, based on the progress information regarding the usage status or usage environment of the cement product CP. Here, the carbon dioxide absorption capacity depends on the condition of the cement product CP and the environment to which the cement product CP is exposed. Therefore, more accurate and reliable data can be acquired by correcting the absorption amount as needed, based on the progress information regarding the usage status and usage environment.

The history management unit 35 manages the correction history and correction results of the corrections executed by the absorption amount correction unit 34. Among the correction contents, the correction history is information on the correction date and time, as well as historical information such as usage status and usage environment. Among the correction contents, the correction result is the outcome of the correction, specifically the result of correcting the carbon dioxide absorption amount (corrected absorption amount). The history management unit 35 may manage and record the correction history and correction results in the storage unit 18, or may use the distributed ledger technology (blockchain) to manage the correction history and correction results. In other words, the blockchain technology may be used to manage the correction contents that have been corrected as needed based on the usage status or usage environment at each stage, such as storage, distribution, use, or secondary use after crushing the cement product CP. In the present embodiment, the usage status and usage environment at each stage, such as storage, distribution, use, or secondary use after crushing of the cement product CP, are tracked; and the carbon dioxide absorption amount is corrected (updated) as needed and stored in a database, based on the progress information regarding the usage status and usage environment. When newly correcting the carbon dioxide absorption amount, a new correction (update) may be implemented on the first correction result managed by the blockchain, such that a second correction history and correction result are generated and managed on the blockchain. As a result, the correction (update) results and history based on the usage status and usage environment of the cement product CP are recorded for each correction, thereby enhancing the reliability of the absorption amount calculation and enabling secure carbon credit transactions.

The certification recording unit 36 records the carbon credits issued for the cement product CP, in association with the cement product CP through collation. Specifically, carbon credits issued (certified) by a predetermined organization, such as the carbon credit certification organization CM, are recorded in association with the cement product CP.

The price determination unit 37 receives the desired price for the sale or purchase of carbon credits, and determines the transaction price for the actually issued carbon credits or the carbon credits scheduled to be issued in the future.

For example, the transaction price may be calculated by multiplying the calculated carbon dioxide absorption amount by a predetermined unit price. Alternatively, the transaction price may be determined based on market conditions (demand) using a system similar to bidding, in accordance with the carbon credit amount. In this case, the price determination unit 37 may determine the transaction price by including costs incurred to acquire carbon credits and a predetermined percentage of the transaction price, as a handling fee.

The price determination unit 37 may determine the transaction price of carbon credits, based on the absorption amount (estimated value) calculated in accordance with the above-mentioned factors. The price determination unit 37 may also determine the transaction price, based on the absorption amount (estimated value) calculated in accordance with the aging and service life of the cement product. In other words, the price determination unit 37 may determine the transaction price for carbon credits expected to be issued in the future, instead of the actually issued carbon credits.

The price determination unit 37 may determine the transaction price, based on the corrected absorption amount, which has been corrected based on progress information. In other words, the price determination unit 37 can treat the carbon credits corresponding to the corrected absorption amount, corrected as needed based on progress information, as futures trading commodities, instead of the actually issued carbon credits.

The price determination unit 37 may determine the transaction price, based on the absorption amount predicted in accordance with the manufacturing plan information of the cement product CP. As a result, the price determination unit 37 can treat future carbon credits (before certification) expected to be issued, in accordance with the manufacturing plan information of cement products CP scheduled for production, as futures trading commodities, instead of the actually issued carbon credits.

Furthermore, the price determination unit 37 may determine the transaction price, based on the absorption amount predicted in accordance with the sales information of the cement CE. As a result, the price determination unit 37 can treat the carbon credits scheduled to be issued in the future, based on cement products CP expected to be manufactured in accordance with the sales information of cement CE, as futures trading commodities, instead of the actually issued carbon credits.

The storage unit 18 of the server 1 illustrated in FIG. 4 includes a carbon dioxide absorption amount information database 41 and a carbon credit information database 42. The carbon dioxide absorption amount information database 41 stores the carbon dioxide absorption amount for cement products, in association with each cement product. The carbon credit information database 42 stores the carbon credits of cement products CP, in association with each cement product.

The carbon dioxide absorption amount information database 41 and the carbon credit information database 42 do not necessarily need to be provided in the storage unit 18 of the server 1, and may instead be stored in external storage devices, such as a cloud server, that communicate with the server 1 via the network N.

Although not illustrated, the server 1 may optionally include a cement product information database, a cement product manufacturing plan information database, and a cement sales information database. The cement product information database stores the product information of the cement product CP described above, along with progress information on the usage status and usage environment of the cement product CP. The cement product manufacturing plan information database stores product information of cement products CP scheduled for production. The cement sales information database stores information on cement CE, such as sales dates and times, sales destinations, types of cement CE, and quantities.

### Processing Details

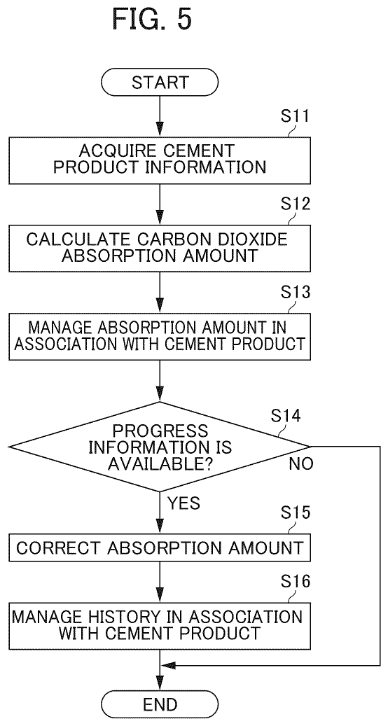

Next, an example of the flow of carbon dioxide absorption amount (estimated value) trace processing in the server 1 will be described. FIG. 5 is a diagram illustrating an example of carbon dioxide absorption amount trace processing according to the present embodiment. In Step S11, the absorption amount calculation unit 31 acquires the cement product information.

In Step S12, the absorption amount calculation unit 31 calculates the carbon dioxide absorption amount during the process until the cement product CP becomes unusable, based on the absorption capacity determined in accordance with the product information. The absorption amount calculation unit 31 may calculate the carbon dioxide absorption amount by considering one or more factors such as the breathability, moisture content, strength, and construction conditions of the cement product CP, or the aging and service life of the cement product CP. Specifically, the absorption amount calculated in Step S12 can be further refined to reflect the actual conditions of the cement product CP by multiplying the absorption amount by a coefficient determined based on the aforementioned factors. For example, it is known that the carbon dioxide absorption amount may change with aging over time and can also change depending on the application of the concrete product or the chemicals added.

In Step S13, the usage status management unit 33 manages the calculated absorption amount in association with each cement product CP, for example, by using the distributed ledger technology.

In Step S14, the absorption amount correction unit 34 determines whether progress information is available. If the absorption amount correction unit 34 determines that progress information is available (S14—YES), the processing proceeds to Step S15. If not (S14—NO), the sequence of operations in the server 1 ends (END).

In Step S15, the absorption amount correction unit 34 corrects (updates) the absorption amount associated with each cement product CP, as needed. The absorption amount correction unit 34 executes correction, based on the progress information regarding the usage status and usage environment of the cement product CP, and manages the corrected absorption amount in association with each cement product.

In Step S16, the history management unit 35 manages the corrected correction history and correction results in association with the cement product using blockchain technology. The basic flow of the carbon dioxide absorption amount trace processing in the server 1 has been described above.

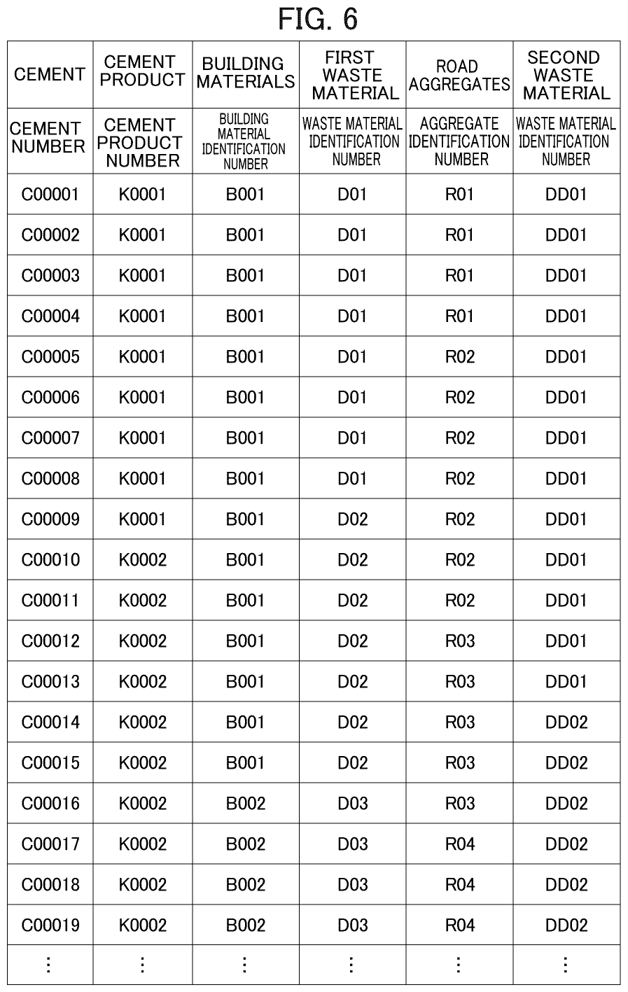

FIG. 6 is a diagram illustrating an example of tracing the carbon dioxide absorption amount. The table illustrated in FIG. 6 can be used to manage (trace), for example, which cement is used for which building material when the cement is distributed step-by-step, from cement products, building materials, first waste materials, road aggregates, to second waste materials. This allows for preventing double issuance, such as issuing carbon credits for the cement itself and additionally for the building materials made from that cement. Consequently, the reliability of carbon credit transactions related to cement products can be ensured. Specifically, the cement number, cement product number, building material identification number, first waste material identification number, road aggregate identification number, and second waste material identification number are managed in association with each other. The cement number is assigned to identify the cement CE used in manufacturing the cement product CP. The cement product number is assigned to identify the cement product CP manufactured using the cement CE. The building material identification number is assigned to identify building materials made from the cement product CP. The first waste material identification number is assigned to identify waste materials (referred to as “first waste material” for convenience) generated from the demolition of building materials. The aggregate identification number is assigned to identify aggregates regenerated from the first waste material obtained by dismantling the building material. The second waste material identification number is assigned to identify the second waste material. Here, the second waste material refers to waste material generated by dismantling the newly formed concrete product, which was made by regenerating the first waste material, which was produced from dismantling the original concrete product. For example, in FIG. 6, it can be understood that part of the cement product K0001, which was manufactured using cement C00003, becomes part of the building material B001, then becomes part of the first waste material D01, further becomes part of the road aggregate R01, and finally becomes part of the second waste material DD01.

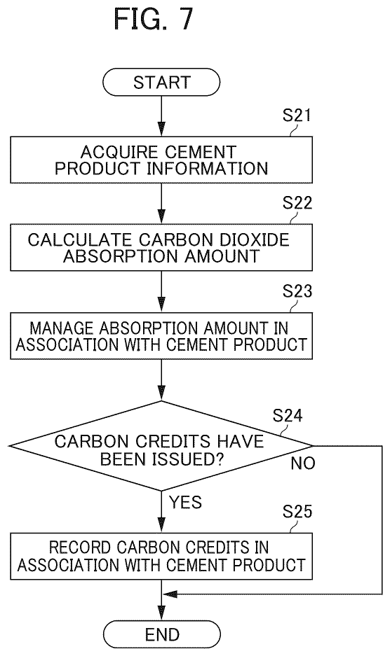

Next, an example of the flow of carbon credit management processing in the server 1 will be described. FIG. 7 is a diagram illustrating an example of the carbon credit management processing according to the present embodiment. Since the processing from Step S21 to Step S23 are the same as the processing from Step S11 to Step S13 described above, detailed descriptions are omitted.

In Step S24, the certification recording unit 36 determines whether carbon credits have been issued (already issued), based on the absorption amount calculated by the absorption amount calculation unit 31.

If the certification recording unit 36 determines that carbon credits have been issued (S24—YES), the processing proceeds to Step S25. If not (S24—NO), the sequence of operations in the server 1 ends (END).

In Step S25, the certification recording unit 36 records the issued carbon credits by matching and associating the credits with the cement product CP. This completes the basic flow of the carbon credit management processing in the server 1.

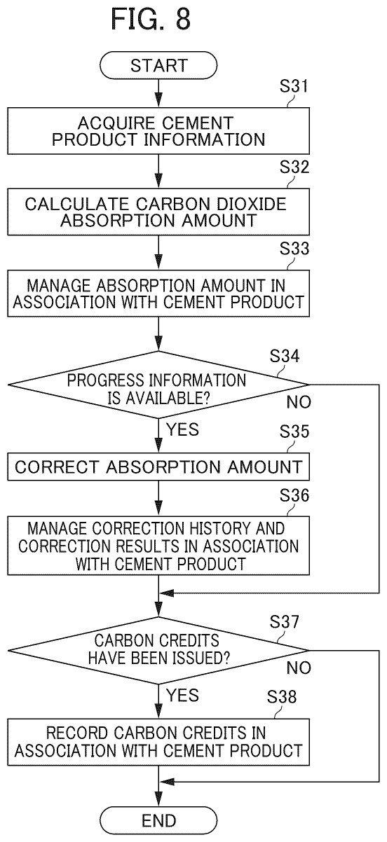

Next, the detailed flow of the carbon credit management processing in the server 1 will be described. FIG. 8 is a diagram illustrating an example of the carbon credit management processing according to the present embodiment. Since the processing from Step S31 to Step S33 are the same as the processing from Step S11 to Step S13 described above, detailed descriptions are omitted. In Step S34, the absorption amount correction unit 34 determines whether progress information is available. If the absorption amount correction unit 34 determines that progress information is available (S34—YES), the processing proceeds to Step S35. If not (S34—NO), the processing proceeds to Step S37. Since the processing in Step S35 is the same as the processing in Step S15 described above, detailed descriptions are omitted.

In Step S36, the history management unit 35 manages the correction history and correction results corrected as needed based on the progress information by the absorption amount correction unit 34, in association with each cement product, using the blockchain technology. Since the processing in Steps S37 and S38 are the same as the processing in Steps S24 and S25 described above, detailed descriptions are omitted.

The absorption amount calculation unit 31 may predict and calculate the carbon dioxide absorption amount during the process until the cement product CP becomes unusable, which was manufactured based on the cement product manufacturing plan information. The absorption amount calculation unit 31 may also predict and calculate the carbon dioxide absorption amount during the process until the cement product CP becomes unusable, which was manufactured based on the sales information of cement CE.

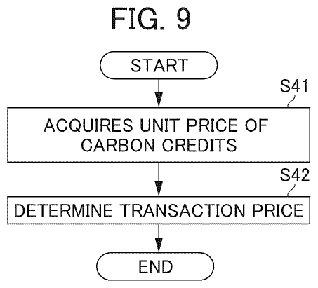

FIG. 9 is a diagram illustrating an example of the transaction price determination processing for carbon credits according to the present embodiment. In Step S41, the price determination unit 37 acquires the unit price of the carbon credits. In Step S42, the price determination unit determines the transaction price by multiplying the calculated carbon dioxide absorption amount by the acquired unit price. The price determination unit 37 may receive the desired transaction price for the sale or purchase of carbon credits, and determine the selling price as the highest desired transaction price among the received offers, based on the minimum desired transaction price among the received desired transaction price. The specific flow of the carbon credit management processing in the server 1 has been described above.

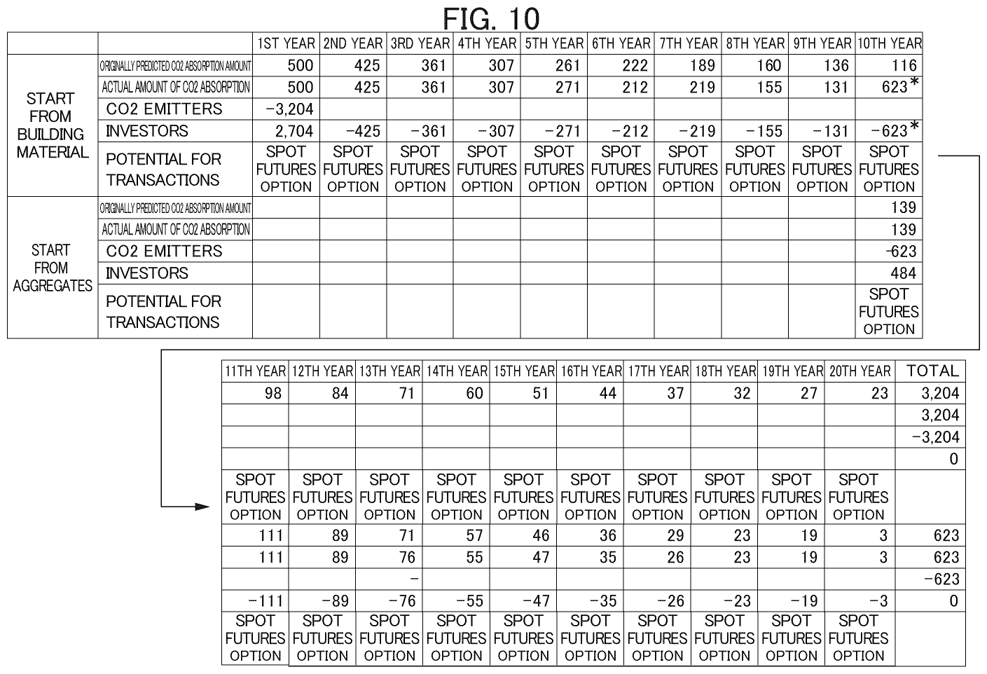

FIG. 10 is a diagram illustrating an example of carbon credit transactions. FIG. 10 illustrates the absorption amount transactions for building materials, including the predicted carbon dioxide absorption amount during the process until the building materials become unusable, the actual carbon dioxide absorption amount, the carbon dioxide emission amount traded by emitters, the carbon dioxide absorption amount traded by investors, and the potential for such transactions. Additionally, FIG. 10 illustrates the transactions for recycled aggregates generated from waste material dismantled building materials, including the predicted carbon dioxide absorption amount during the process until the building materials become unusable, the actual carbon dioxide absorption amount, the carbon dioxide emission amount traded by emitters, the carbon dioxide absorption amount traded by investors, and the potential for such transactions. In other words, the illustration helps understand the transactions of carbon dioxide absorption amounts, in a case where the building material is used from the first to ninth years and then dismantled in the tenth year for use as aggregate.

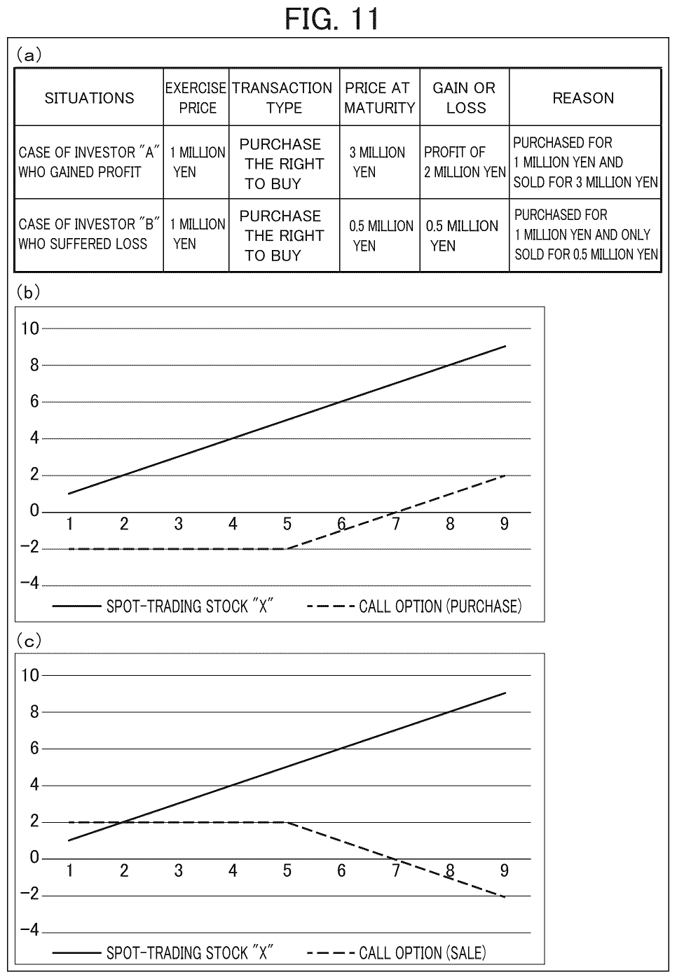

FIGS. 11(a) to 11(c) illustrate an example of a call option in carbon credit transactions. For instance, if Investor KO purchases the right to buy carbon credits for 1 million yen, and the price rises to 3 million yen at maturity, the profit would be 2 million yen. Conversely, if Investor OTSU purchases the right to buy carbon credits for 1 million yen, and the price drops to 0.5 million yen at maturity, the loss would be 0.5 million yen (FIG. 11(a)). In order to assess the profit and loss in carbon credit transactions, the graphs as illustrated in FIGS. 11(b) and 11(c) can be used to make projections. The transactions of the carbon dioxide absorption amount may be conducted in units of the weight of the cement product CP (e.g., 10 tons) or by the number of building units as the building material (e.g., 10 buildings). While the absorption amount in the former remains constant, the absorption amount in the latter may fluctuate due to property transfers.

### Advantageous Effects of Present Embodiment

As described above, the server in the present embodiment can correct the carbon dioxide absorption capacity (absorption amount) of the cement product CP as needed, based on trace information regarding the usage status and usage environment of the cement product CP. Specifically, the server can trace the usage status and usage environment of the cement product CP during a period from the time of producing the cement product CP until the cement product CP becomes unusable, and update the carbon dioxide absorption amount of the cement product CP as needed, storing this data in a database based on the progress information. Furthermore, the server in the present embodiment can calculate the carbon dioxide absorption amount during the process until the cement product CP becomes unusable, and manage the carbon credits issued based on this absorption amount in association with each cement product CP. In other words, the server can manage the carbon credits issued based on the carbon dioxide absorption amount calculated or managed by the server. Therefore, highly reliable and precise data can be ensured for managing carbon dioxide absorption amounts. Consequently, transactions of carbon credits issued based on this absorption amount can be conducted with confidence.

The embodiment of the present invention has been described above; however, the described embodiment is merely an example to facilitate the understanding of the present invention and is not intended to limit the invention. The present invention is not limited to the above-described embodiment, and modifications and improvements within the scope of achieving the object of the present invention are included in the present invention.

### Modification Example

In the above-described embodiment, carbon dioxide, which is a representative example of greenhouse gases known to have a greenhouse effect, has been described as the subject of transactions; however, the present invention is not limited to this. For example, other acidic gases potentially reacting with cement hydrates in concrete and serving as greenhouse gases, such as methane (CH₄), nitrous oxide (N₂O), hydrofluorocarbons (HFCs), perfluorocarbons (PFCs), sulfur hexafluoride (SF₆), and nitrogen trifluoride (NF₃), may also be targeted for tracing, management, or transactions.

### Other Variations

The series of processing described above can be executed by hardware or implemented by software. In other words, the above-mentioned functional configurations are merely examples and are not particularly limited. As long as the information processing system is equipped with the function to execute the series of processing as a whole, the specific functional blocks used to achieve this function are not limited to the above examples.

The locations of the functional blocks are not limited to those illustrated in FIG. 4 and may be arbitrarily assigned. For example, the functional blocks of the server may be delegated to other devices. Conversely, the functional blocks of other devices may be integrated into the server. Each functional block may be implemented solely with hardware, solely with software, or a combination of both.

When executing the series of processing via software, the program constituting the software is installed on a computer from a network or a recording medium. The computer may be embedded in dedicated hardware. Alternatively, the computer may be a computer capable of executing various functions by installing various programs, such as a general-purpose smartphone, a personal computer, or a server.

A recording medium containing such a program may be distributed to users as a removable media (not illustrated) separate from the device itself or may be provided pre-installed in the device. Since the program can also be distributed via a network, the recording medium may be installed on or accessible by a computer connected to or connectable to a network.

In this specification, the steps of describing programs recorded on a recording medium include not only processing executed sequentially but also processing executed in parallel or individually, even if not executed in chronological order. The term “system” in this specification refers to an overall apparatus composed of a plurality of devices or means.

The embodiments described above are merely examples for facilitating the understanding of the present invention and do not limit the technical scope of the invention. The present invention can take various other embodiments, and it is also possible to combine the configurations of the above embodiments and modifications. Furthermore, various changes, omissions, or substitutions can be made without departing from the spirit of the present invention. These embodiments and modifications are included in the scope and spirit of the invention described in this specification and the scope of the claims, including their equivalents.

### EXPLANATION OF REFERENCE NUMERALS

1: server
2: cement product business operator terminal
3: cement producer terminal
4: monitoring device
5: carbon credit management device
6: trader terminal
11: CPU
18: storage unit
19: communication unit
31: absorption amount calculation unit
32: absorption amount acquisition unit
33: usage status management unit
34: absorption amount correction unit
35: history management unit
36: certification recording unit
37: price determination unit
41: carbon dioxide absorption amount information database
42: carbon credit information database

1. An information processing apparatus, comprising:
an absorption amount acquisition unit configured to acquire an estimated value of a greenhouse gas absorption amount during a process until a greenhouse gas-absorbing product becomes unusable, based on a greenhouse gas absorption capacity determined in accordance with product information on the greenhouse gas-absorbing product;
a usage status management unit configured to manage the absorption amount acquired, in association with each greenhouse gas-absorbing product; and
an absorption amount correction unit configured to correct the absorption amount associated with each greenhouse gas-absorbing product as needed, based on progress information on a processing status, a usage status, or a usage environment of the greenhouse gas-absorbing product.

2. An information processing apparatus, comprising:
an absorption amount acquisition unit configured to acquire an estimated value of a greenhouse gas absorption amount during a process until a greenhouse gas-absorbing product becomes unusable, based on a greenhouse gas absorption capacity determined in accordance with product information on the greenhouse gas-absorbing product;
a usage status management unit configured to manage the greenhouse gas absorption amount acquired, in association with each greenhouse gas-absorbing product; and
a certification recording unit configured to record a carbon credit issued for the greenhouse gas-absorbing product by matching and associating the carbon credit with the greenhouse gas-absorbing product.

3. The information processing apparatus according to claim 1, further comprising a history management unit configured to manage a correction history and a correction result corrected by the absorption amount correction unit, in association with each greenhouse gas-absorbing product.

4. The information processing apparatus according to claim 1, wherein
the product information includes at least one of a type, amount, or composition of a raw material used in the greenhouse gas-absorbing product, breathability, moisture content, strength, or construction conditions of the greenhouse gas-absorbing product, and
the absorption amount acquisition unit acquires an estimated value of the absorption amount, based on an absorption capacity determined in accordance with the product information.

5. The information processing apparatus according to claim 1, wherein the product information includes aging and service life of the greenhouse gas-absorbing product.

6. The information processing apparatus according to claim 2, further comprising a transaction price determination unit configured to determine a transaction price of the carbon credit to be issued in future.

7. An information processing method, comprising:
an absorption amount acquiring step of acquiring an estimated value of a greenhouse gas absorption amount during a process until a greenhouse gas-absorbing product becomes unusable, based on a greenhouse gas absorption capacity determined in accordance with product information on the greenhouse gas-absorbing product;
a usage status managing step of managing the absorption amount acquired, in association with each greenhouse gas-absorbing product; and
an absorption amount correcting step of correcting the absorption amount associated with each greenhouse gas-absorbing product as needed, based on progress information regarding a processing status, a usage status, or a usage environment of the greenhouse gas-absorbing product.

8. An information processing method, comprising:
an absorption amount acquiring step of acquiring an estimated value of a greenhouse gas absorption amount during a process until a greenhouse gas-absorbing product becomes unusable, based on a greenhouse gas absorption capacity determined in accordance with product information on the greenhouse gas-absorbing product;
a usage status managing step of managing the absorption amount acquired, in association with each greenhouse gas-absorbing product; and
a certification recording step of recording a carbon credit issued for the greenhouse gas-absorbing product by matching and associating the carbon credit with the greenhouse gas-absorbing product.

9. A non-transitory computer readable medium storing a computer program for causing a computer to execute:
an absorption amount acquiring step of acquiring an estimated value of a greenhouse gas absorption amount during a process until a greenhouse gas-absorbing product becomes unusable, based on a greenhouse gas absorption capacity determined in accordance with product information on the greenhouse gas-absorbing product;
a usage status managing step of managing the absorption amount acquired, in association with each greenhouse gas-absorbing product; and
an absorption amount correcting step of correcting the absorption amount associated with each greenhouse gas-absorbing product as needed, based on progress information regarding a processing status, a usage status, or a usage environment of the greenhouse gas-absorbing product.

10. A non-transitory computer readable medium storing a computer program for causing a computer to execute:
an absorption amount acquiring step of acquiring an estimated value of a greenhouse gas absorption amount during a process until a greenhouse gas-absorbing product becomes unusable, based on a greenhouse gas absorption capacity determined in accordance with product information on the greenhouse gas-absorbing product;
a usage status managing step of managing the absorption amount acquired, in association with each greenhouse gas-absorbing product; and
a certification recording step of recording a carbon credit issued for the greenhouse gas-absorbing product by matching and associating the carbon credit with the greenhouse gas-absorbing product.
